(19) United States
(12) Patent Application Publication
(10) Pub. No.: US 2023/0096100 A1
(43) Pub. Date: Mar. 30, 2023

(54) CONTINUOUS FEED DYE SUBLIMATION APPARATUS FOR FACILITATING CONTINUOUS SUBLIMATION CYCLES

(71) Applicant: Sekisui Kydex LLC, Bloomsburg, PA (US)

(72) Inventors: Jeffrey Humenick, Bloomsburg, PA (US); Jym Kauffman, Bloomsburg, PA (US); Rebecca Gallup, Bloomsburg, PA (US)

(73) Assignee: Sekisui Kydex LLC, Bloomsburg, PA (US)

(21) Appl. No.: 17/950,878

(22) Filed: Sep. 22, 2022

Related U.S. Application Data
(60) Provisional application No. 63/249,529, filed on Sep. 28, 2021.

(51) Int. Cl. B41M 5/382; B41J 11/00

(52) U.S. Cl. CPC B41M 5/382; B41J 11/007

(57) ABSTRACT

An illustrative dye sublimation apparatus (also referred to as a dye sublimation machine) may have a pair of conveyor belts to perform continuous sublimation cycles using a continuous feed of printed sheet and substrate. For example, the continuous feed dye sublimation apparatus may receive substrate directly from an extrusion machine, which saves time and effort over traditional methods that require separate preparing and loading steps. The pair of conveyor belts may then apply pressure and heat to the printed sheet and substrate in order to facilitate dye sublimation.

### CROSS-REFERENCE TO RELATED APPLICATIONS

This application claims the benefit of and priority to U.S. Provisional Application No. 63/249,529, filed Sep. 28, 2021, the entire disclosure of which is incorporated by reference herein.

### TECHNICAL FIELD

This application is directed generally towards a dye sublimation apparatus (also referred to as a dye sublimation machine), and more specifically towards a continuous feed dye sublimation apparatus that receives a running feed of printing sheet and substrate rather than discrete sheets.

### BACKGROUND

Dye sublimation is a process of infusing images to a substrate. An image to be infused is printed on a paper (or any type of sheet) using sublimation dyes (contained in the sublimation inks) and the printed paper is pressed against a substrate (e.g., a thermoplastic or a fabric) under heat. The heat causes the dyes to sublimate from a solid state on the printed paper into a gaseous state and travel into the substrate, where the dyes get deposited as solids. This sublimation process therefore infuses the image in the printed paper into the substrate. As the infused image is embedded within the substrate, the image may not chip, fade, or delaminate like the capped and printed images.

A dye sublimation cycle performed by a conventional dye sublimation apparatus has three linear steps: loading, heating, and unloading. As shown in FIG. 1, at a loading step 114, a worker 120 loads a printed sheet 108 and a substrate 110 onto a bed 112. At a next heating step 116, heater banks 102 (formed by a plurality of heating elements) generate radiating heat 104 that causes dyes in the printed sheet 108 to sublimate from a solid state to a gaseous state and travel into the substrate 110 in the gaseous state. The dyes then get deposited as solids into the substrate 110 thereby infusing an image formed by the dyes on the printed sheet 108 into the substrate 110. A membrane 106 generally covers and keeps the printed sheet 108 and the substrate 110 pressed against each other. After the heating step 116, the worker 120 unloads the substrate 110 containing the infused image at an unloading step 118.

However, the above described sublimation cycle performed by a conventional dye sublimation apparatus with the linear steps has several technical shortcomings. For example, the heating step 116 generally takes about twelve minutes, and after the heating is completed, the worker 120 has to wait for the dye sublimation apparatus to cool down before unloading the substrate 110 at the unloading step 118. The dye sublimation apparatus cannot be used for a next sublimation cycle until the substrate 110 from the current cycle is unloaded at the unloading step 118. In other words, the worker 120 after the loading step 114 has to wait for the dye sublimation apparatus to heat up, heat the printed sheet 108, and cool down until the substrate 110 with the infused image is ready be unloaded at the unloading step 118. This process has a significant amount of down time and is therefore significantly inefficient. Furthermore, for each sublimation cycle, the printed sheet 108 and the substrate 110 must be fitted with the membrane 106 in order to keep the printed sheet 108 and the substrate 110 pressed together, even if the printed sheet 108 and the substrate 110 are the same size as for the previous sublimation cycle. A necessity for this repeated action further contributes to the inefficiency of conventional dye sublimation cycles.

### SUMMARY

What is therefore desired are dye sublimation systems and methods that may operate a continuous sublimation cycle in its multiple discrete steps such that multiple steps from multiple sublimation cycles can be performed simultaneously. What is further desired are dye sublimation systems and methods that facilitate a continuous feed of printed sheet and substrate in order to reduce the amount of manual labor and time associated with tradition dye sublimation methods.

Embodiments described herein attempt to solve the aforementioned technical problems and may provide other benefits as well. An illustrative continuous feed dye sublimation apparatus (also referred to as a dye sublimation machine) has a pair of conveyor belts to perform continuous sublimation cycles using a continuous feed of printed sheet and substrate. For example, the continuous feed dye sublimation apparatus may receive substrate directly from an extrusion machine, which saves time and effort over traditional methods that require separate preparing and loading steps.

In one embodiment, a continuous feed dye sublimation machine for infusing an image from a printed sheet into a substrate, the dye sublimation machine comprising one or more conveyor belts, the one or more conveyor belts structured to receive the printed sheet and the substrate and apply pressure to the printed sheet and the substrate; and a plurality of heating elements, the plurality of heating elements contained within the one or more conveyor belts and structured to heat the sheet to sublimate one or more dyes forming the image, such that the one or more dyes travel into the substrate in a gaseous state and deposit in the substrate in a solid state thereby infusing the image into the substrate, wherein at least one of the printed sheet or the substrate are received in a substantially continuous feed.

It is to be understood that both the foregoing general description and the following detailed description are exemplary and explanatory and are intended to provide further explanation of the disclosed embodiment and subject matter as claimed.

### BRIEF DESCRIPTION OF THE DRAWINGS

The accompanying drawings constitute a part of this specification and illustrate embodiments of the subject matter disclosed herein.

FIG. 1 shows a conventional dye sublimation cycle.

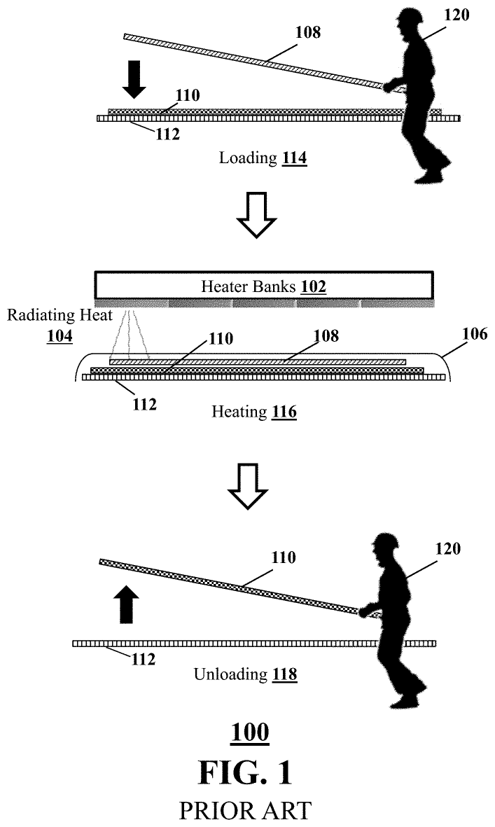

FIG. 2 shows a first illustrative continuous feed dye sublimation apparatus, according to an embodiment.

FIG. 3 shows a second illustrative continuous feed dye sublimation apparatus, according to an embodiment.

FIG. 4 shows an illustrative system with a continuous feed dye sublimation apparatus, according to an embodiment.

FIG. 5 shows a flow diagram of an illustrative method for dye sublimation utilizing a continuous feed dye sublimation apparatus, according to an embodiment.

### DETAILED DESCRIPTION

Reference will now be made to the illustrative embodiments illustrated in the drawings, and specific language will be used here to describe the same. It will nevertheless be understood that no limitation of the scope of the claims or this disclosure is thereby intended. Alterations and further modifications of the inventive features illustrated herein, and additional applications of the principles of the subject matter illustrated herein, which would occur to one ordinarily skilled in the relevant art and having possession of this disclosure, are to be considered within the scope of the subject matter disclosed herein. The present disclosure is here described in detail with reference to embodiments illustrated in the drawings, which form a part herein. Other embodiments may be used and/or other changes may be made without departing from the spirit or scope of the present disclosure. The illustrative embodiments described in the detailed description are not meant to be limiting of the subject matter presented here.

Embodiments disclosed herein describe systems and methods for dye sublimation utilizing a continuous feed dye sublimation apparatus. An illustrative continuous feed dye sublimation apparatus has a pair of conveyor belts to perform continuous sublimation cycles using a continuous feed of printed sheet and substrate. For example, the continuous feed dye sublimation apparatus may receive substrate directly from an extrusion machine, which saves time and effort over traditional methods that require separate preparing and loading steps. The pair of conveyor belts may then apply pressure and heat to the printed sheet and substrate in order to facilitate dye sublimation.

The pair of conveyor belts apply a constant pressure to the printed sheet and substrate to keep the combination pressed together, similarly to a traditional membrane but reducing the effort required to place and fit the membrane for each sublimation cycle. Furthermore, the conveyor belts are heated via one or more heating elements in order to cause the dyes in the printed sheet to sublimate in a more efficient manner than the radiating heat of traditional methods. The one or more heating elements may be individually controlled to maintain a near-constant temperature across the entire conveyor belt or to maintain a temperature gradient, such that the conveyor belt features a pre-heating zone and a heating zone.

In some embodiments, the one or more heating elements include a heater that may pass a heated fluid (e.g., air, water, or oil) through tubings (e.g., copper tubing) in a front zone of the conveyor belts. The heated fluid may impart its heat to the printed sheet and the substrate to optimize dye sublimation at the heating station. A connect mechanism may connect with the conveyor belts to pass the heated fluid through the tubing in the conveyor belts. The heated fluid may pass through in several cycles before a desired temperature is reached at the front zone.

The one or more heating elements may further heat a combination of a (pre-heated) printed sheet and a substrate such that the dyes forming an image on the printed sheet sublimate and travel into the substrate to be deposited as solids. To generate the heat, the heating elements may be grouped into several individually controllable heaters. The heating elements may be electric, e.g., heating coils, but any other type of electrical and/or chemical sources of heat should be considered within the scope of this disclosure.

One or more processors (to be broadly read to include both microprocessors and controllers) may control the operation of the dye sublimation apparatus and one or more of the components. For example, a processor may control the speed of the conveyor belts in order to affect the amount of time that the printed sheet and substrate remain in the dye sublimation apparatus. The processor may also control the one or more heating elements to establish a heating gradient along the conveyor belts to pre-heat a combination of printed sheet and substrate thereon to a requisite temperature in a front zone and heat the combination to cause dye sublimation in an end zone. The processor may control these operations in the dye sublimation apparatus based upon user inputs (e.g., configuration parameters provided by the worker on an interface associated with the dye sublimation apparatus) and/or environmental variables such as ambient temperature.

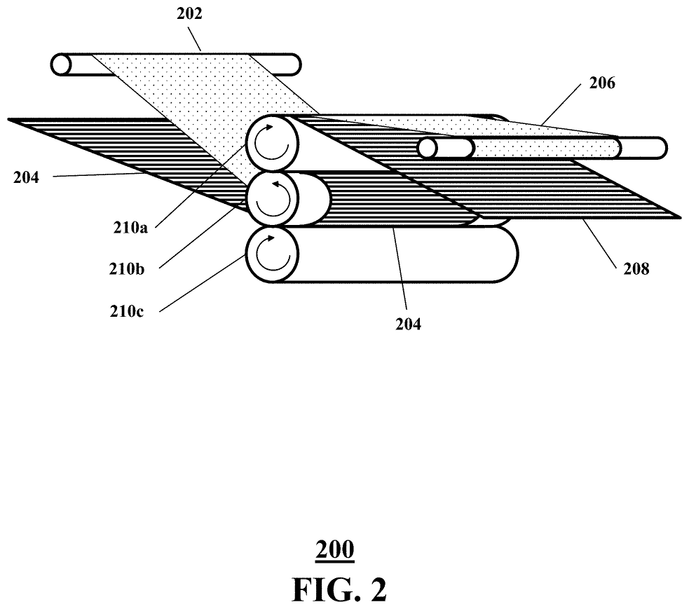

FIG. 2 shows a first illustrative continuous infusion sublimation machine (also referred to as dye sublimation apparatus) 200, according to an embodiment. It should be understood that the dye sublimation machine 200 shown in FIG. 2 and described herein is merely for illustration and explanation and machines with other form factors and components should also be considered within the scope of this disclosure. For example, dye sublimation machines having additional, alternative, or a fewer number of components than the illustrative dye sublimation machine 200 should be included within the scope of this disclosure.

As shown, the dye sublimation machine 200 is a continuous infusion machine structured to complete a sublimation cycle (also referred to as dye sublimation cycle). The dye sublimation machine 200 includes a plurality of rolls 210a, 210b, and 210c (collectively or commonly referred to as 210). The plurality of rolls 210 are structured to receive a printed sheet 202 and a substrate 204, and to rotate either clockwise or counter-clockwise in order to advance the printed sheet 202 and the substrate 204 through the dye sublimation machine 200. For example, as shown in FIG. 2, rolls 210a and 210c rotate clockwise, and roll 210b rotates counter-clockwise. However, various alternative combinations of clockwise and counter-clockwise rotation may be contemplated. A processor may control the rotating movement of the plurality of rolls 210 based upon user inputs or other environmental variables. The plurality of rolls 210 may provide a pressure such that that the printed sheet 202 and the substrate 204 press against each other during the corresponding sublimation cycles.

One or more of the plurality of rolls 210 may provide heat to the printed sheet 202 and the substrate 204 in order to sublimate the dyes forming an image on the printed sheet 202. The sublimated dyes travel to the substrate 204 and deposit therein thereby infusing the image into the substrate 204. Once the dyes have sublimated, a blank printed sheet 206 and a printed substrate 208 advance from the dye sublimation machine 200. In some embodiments, only the plurality of rolls 210 that make contact with both the printed sheet 202 and the substrate 204 are heated (e.g., roll 210a and 210b), such that heat is applied to the combination of the printed sheet 202 and the substrate 204 but not to the printed sheet 202 and the substrate 204 individually. In other embodiments, all of the plurality of rolls 210 are heated, such that the printed sheet 202 and the substrate 204 are pre-heated before being pressed together.

The plurality of rolls 210 may include heating elements in any type configuration within the plurality of rolls. The heating elements may be electrically providing a radiative type heating to the combination of the printed sheet and the substrate, and may be individually controlled by a processor. The heating elements may also be divided into a plurality of zones, each zone containing one or more heaters. Therefore, the processor may individually control the heat output of each zone to maintain a consistent temperature across the plurality of rolls. For example, if a portion of the printed sheet 202 and the substrate 204 are being overheated, the heat output of the zone coming into contact with the overheated portions can be turned down (e.g., reducing the radiating heat).

In some embodiments, particularly in those in which the plurality of rolls 210 are providing a pre-heating function, the plurality of rolls 210 may feature a fluid heating mechanism. A heater (not pictured) may heat a fluid (e.g., air, water, oil) and pass the heated fluid through tubing (e.g., copper tubing) in the plurality of rolls. When the heated fluid passes into the plurality of rolls 210, the heated fluid may move through the tubing within the plurality of rolls 210, dissipating its heat to the printed sheet and the substrate. After this movement, the fluid may pass back to the heater. In order to provide a desired amount of heat, there may be multiple passes of heated fluid through the tubing within the plurality of rolls 210 to provide the desired amount of heat. For example, if the plurality of rolls 210 are heating the printed sheet 202 and the substrate 204 in order to sublimate the dyes, there may be more passes of heated fluid as opposed to if the plurality of rolls 210 are pre-heating the printed sheet 202 and the substrate 204. A processor may control the heater based upon inputs from the worker and/or other environmental variables (e.g., ambient temperature).

As described above one or more processors may control the operation of the dye sublimation apparatus 200, including the operation of each of the plurality of rolls 210 and corresponding apparatuses thereon. For example, a processor may control the rotation of the plurality of rolls 210 thereby controlling the speed at which the printed sheet 202 and substrate 204 advance through the dye sublimation apparatus 200. The processor may control the heater elements in the plurality of rolls 210 (or the heater, if the fluid heating mechanism is used) a requisite heating temperature for pre-heating or dye sublimation. Therefore, the processor may be programmed to configure the operation of the dye sublimation apparatus 200.

Because the printed sheet 202 and the substrate 204 must both be pliable and flexible in order to pass through the plurality of rolls 210 due to the weaving around the various plurality of rolls 210, the dye sublimation machine 200 may preferably be used for relatively thin gauges of substrate (e.g., less than 0.028 inch) or film. However, the plurality of rolls 210 may be spaced or positioned differently in order to reduce bending or distortion, such that the dye sublimation machine 200 can receive substrates of relatively thicker gauge.

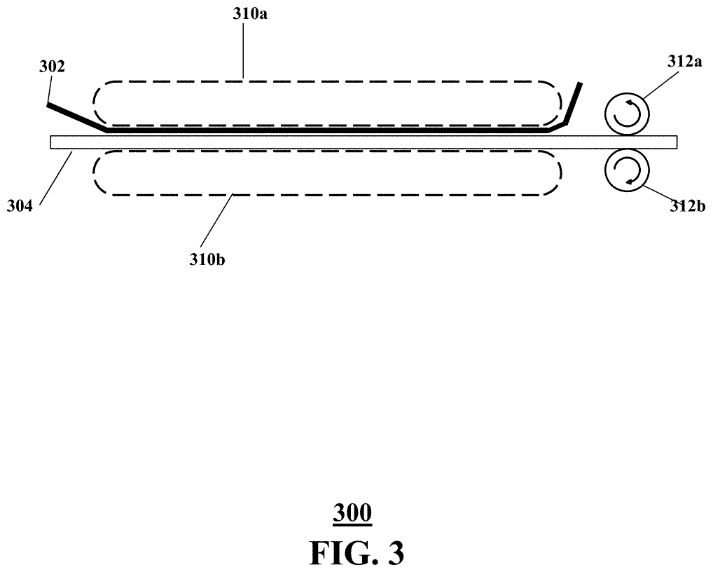

FIG. 3 shows a second illustrative continuous infusion sublimation machine (also referred to as dye sublimation apparatus) 300, according to an embodiment. It should be understood that the dye sublimation machine 300 shown in FIG. 3 and described herein is merely for illustration and explanation and machines with other form factors and components should also be considered within the scope of this disclosure. For example, dye sublimation machines having additional, alternative, or a fewer number of components than the illustrative dye sublimation machine 300 should be included within the scope of this disclosure.

As shown, the dye sublimation machine 300 is a continuous infusion machine structured to complete a sublimation cycle (also referred to as dye sublimation cycle). The dye sublimation machine 300 includes a first conveyor belt 310a and a second conveyor belt 310b (collectively and commonly referred to as the conveyor belts 310), which are structured to receive a printed sheet 302 and a substrate 304 and advance the printed sheet 302 and the substrate 304 through the dye sublimation machine 300. A processor may control the movement of the conveyor belts 310 based upon user inputs or other environmental variables. The conveyor belts 310 may provide a pressure such that that the printed sheet 302 and the substrate 304 press against each other during the corresponding sublimation cycles.

One or more of the conveyor belts 310 may provide heat to the printed sheet 302 and the substrate 304 in order to sublimate the dyes forming an image on the printed sheet 302. The sublimated dyes travel to the substrate 304 and deposit therein thereby infusing the image into the substrate 304. In some embodiments, only the first conveyor belt 310a is heated, such that heat is applied to the top of the printed sheet 302 but not to the bottom of the substrate 304. In other embodiments, both of the conveyor belts 310 are heated, such that the printed sheet 302 and the substrate 304 are each directly heated.

The conveyor belts 310 may include heating elements in any type configuration within the conveyor belts 310. The heating elements may be electrically providing a radiative type heating to the combination of the printed sheet 302 and the substrate 304, and may be individually controlled by a processor. The heating elements may also be divided into a plurality of zones, each zone containing one or more heaters. Therefore, the processor may individually control the heat output of each zone to maintain a consistent temperature across the conveyor belts 310. Alternatively, the processor may individually control the heat output of each zone to maintain a heat gradient across the conveyor belt 310. For example, the processor may command a relatively lower heat output at zones towards the front (i.e., the point at which the printed sheet 302 and the substrate 304 enter the dye sublimation machine 300) to effectively pre-heat the printed sheet 302 and the substrate 304, and may command increasing heat output in zones farther along the conveyor belts (i.e., in the direction of movement of the printed sheet 302 and the substrate 304).

In some embodiments, the conveyor belts 310 may feature a fluid heating mechanism. A heater (not pictured) may heat a fluid (e.g., air, water, oil) and pass the heated fluid through tubing (e.g., copper tubing) in the conveyor belts 310. When the heated fluid passes into the conveyor belts 310, the heated fluid may move through the tubing within the conveyor belts 310, dissipating its heat to the printed sheet 302 and the substrate 304. After this movement, the fluid may pass back to the heater. In order to provide a desired amount of heat, there may be multiple passes of heated fluid through the tubing within the conveyor belts 310 to provide the desired amount of heat. A processor may control the heater based upon inputs from the worker and/or other environmental variables (e.g., ambient temperature).

As described above one or more processors may control the operation of the dye sublimation apparatus 300, including the operation of each of the conveyor belts 310 and corresponding apparatuses thereon. For example, a processor may control the speed of the conveyor belts 310 thereby controlling the speed at which the printed sheet 302 and substrate 304 advance through the dye sublimation apparatus 300. The processor may control the heater elements in the conveyor belts 310 (or the heater, if the fluid heating mechanism is used) a requisite heating temperature for pre-heating or dye sublimation. Therefore, the processor may be programmed to configure the operation of the dye sublimation apparatus 300.

In contrast to the dye sublimation apparatus 200 of FIG. 2, the dye sublimation apparatus 300 is structured to allow the substrate 304 to remain substantially flat throughout the entire sublimation cycle. As such, there is no pliability or flexibility requirement for the substrate 304, such that the dye sublimation apparatus 300 can receive substrates of any gauge (i.e., thin or thick).

The dye sublimation machine 300 may include texture or embossing rolls 312a and 312b (collectively and commonly referred to as the embossing rolls 312), which may provide texture (e.g., physical structure) to a printed substrate after it leaves conveyer belts 310a, 310b or the dye sublimation machine 300. In one embodiment, the rolls 312 may be utilized in conjunction with the dye sublimation apparatus 200 shown in FIG. 2.

Because each of the dye sublimation apparatus 200 of FIG. 2 and the dye sublimation apparatus 300 of FIG. 3 is structured to receive a continuous feed of printing sheet and substrate, in some embodiments, an extrusion machine may directly feed into the dye sublimation apparatus. The extrusion machine is any sort of device or apparatus that receives raw materials for a substrate, combines and compresses the raw materials into the desired shape and thickness for the substrate, heats the raw materials to bind them together, and then outputs a substrate. Traditionally, the extrusion process is a separate process that produces substrates that are then stored until use, at which point they may need to be trimmed or otherwise prepared for loading into a traditional dye sublimation apparatus. In contrast, because the dye sublimation apparatuses of FIGS. 2-3 are structured to receive a continuous feed of substrate, the storing, trimming, and preparing steps may be omitted, which saves time, space, and effort.

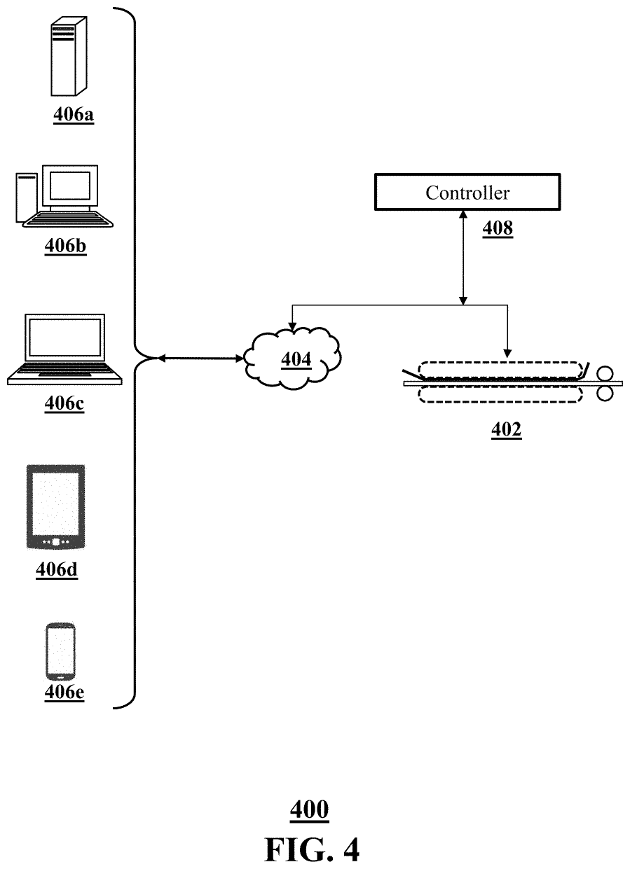

FIG. 4 shows an illustrative system 400 for dye sublimation, according to an embodiment. As shown, the system 400 may comprise a dye sublimation apparatus (also referred to as a dye sublimation machine) 402, a network 404, computing devices 406a, 406b, 406c, 406d, 406e (collectively or commonly referred to as 406), and a controller 408. It should be understood that the system 400 and the aforementioned components are merely for illustration and systems with additional, alternative, and a fewer number of components should be considered within the scope of this disclosure.

The dye sublimation apparatus 402 may be a combination of components that may infuse (or dye sublimate) an image from multiple printed sheets to corresponding substrates. The images may be printed using sublimation inks containing sublimation dyes that may transform from solid state to gaseous state when heated to a predetermined temperature. The sublimation dyes may travel to the corresponding substrates and deposit therein thereby generating infused image within the substrates. To support continuous sublimation cycles utilizing a continuous stream of printed sheets and substrates, the dye sublimation apparatus 402 comprises a pair of conveyor belts. The dye sublimation apparatus 402 receives a continuous feed of printed sheet and substrate (e.g., directly from an extrusion machine) and advances the printed sheet and substrate through the dye sublimation apparatus 402 while applying pressure and heat to facilitate the dye sublimation. Therefore, the dye sublimation apparatus 402 may support a substantially continuous and uninterrupted dye sublimation cycle.

A controller 408 may control various operations of the dye sublimation apparatus 402. The controller 408 may be any kind of programmable hardware controller. In the example embodiment, the controller 408 may control a speed of the dye sublimation cycle (e.g., by altering a speed of the conveyor belts) or a temperature of the conveyor belts. In addition to the controller 408, the dye sublimation apparatus 402 may be controlled based upon instructions provided by a computing device 406. For example, the computing device 406 may include an interface for a user to enter a desired amount of temperature at the heating station and the computing device 406 may provide instructions to the heating station through the network 404 to maintain such temperature. Alternatively or additionally, the computing device 406 may provide the instructions to maintain the temperature to the controller 408. In some embodiments, the computing device 406 may provide instructions to the dye sublimation apparatus 402 to maintain a first temperature at a front zone of the conveyor belts and a second higher temperature towards a middle or end zone of the conveyor belts. It should be understood that the instructions to maintain the corresponding temperatures may be implemented either in hardware, e.g., through the controller 408, or as a combination of hardware and software, e.g., through one or more applications in the computing device 406, the controller 408, and/or other hardware components in the dye sublimation apparatus. It should however be understood that these are just but a few illustrations of control of the dye sublimation apparatus 402 by the computing devices 406 and/or the controller 408 and should not be considered limiting. Any type of control causing the dye sublimation apparatus 402 to configure and/or modify its operations should be considered within the scope of this disclosure.

The computing devices 406 may include any type processor-based device that may execute one or more instructions (e.g., instructions to maintain different temperatures at different zones across the conveyor belts) to the dye sublimation apparatus 402 through the network 404. Non-limiting examples of the computing devices 406 include a server 406a, a desktop computer 406b, a laptop computer 406c, a tablet computer 406d, and a smartphone 406e. However, it should be understood that the aforementioned devices are merely illustrative and other computing devices should also be considered within the scope of this disclosure. At minimum, each computing device 406 may include a processor and non-transitory storage medium that is electrically connected to the processor. The non-transitory storage medium may store a plurality of computer program instructions (e.g., operating system, applications) and the processor may execute the plurality of computer program instructions to implement the functionality of the computing device 406.

The network 404 may be any kind of local or remote network that may provide a communication medium between the computing devices 406 and the dye sublimation apparatus 402. For example, the network 404 may be a local area network (LAN), a desk area network (DAN), a metropolitan area network (MAN), or a wide area network (WAN). However, it should be understood that aforementioned types of networks are merely illustrative and any type of component providing the communication medium between the computing devices 406 and the dye sublimation apparatus 402 should be considered within the scope this disclosure. For example, the network 404 may be a single wired connection between a computing device 406 and the dye sublimation apparatus 402.

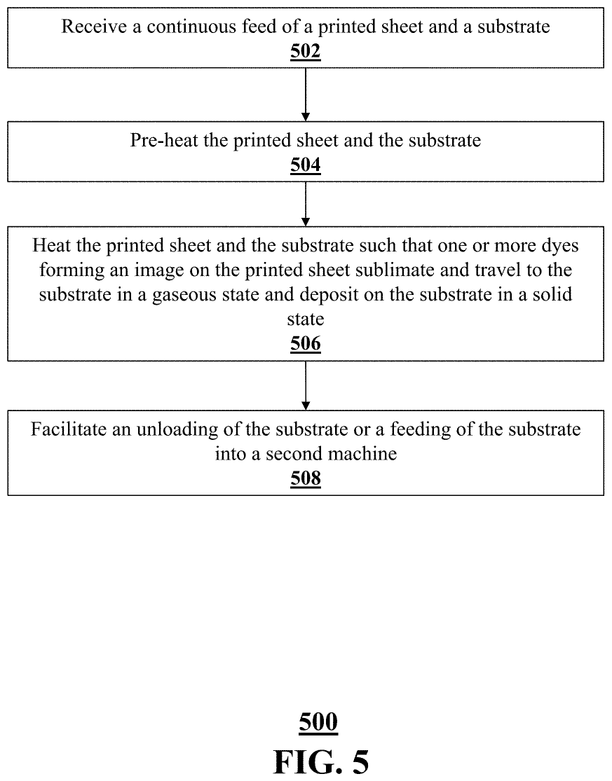

FIG. 5 shows a flow diagram of an illustrative method 500 for dye sublimation, according to an embodiment. The steps of the method 500 described herein are merely illustrative and methods with alternative, additional, and fewer number of steps should also be considered within the scope of this disclosure. It should further be understood that conveyer belts of a dye sublimation apparatus are merely illustrative and additional, alternate, or fewer number of conveyer belts or a different mechanism for progressing the printed sheet and substrate should be considered within the scope of this disclosure.

The method may begin at a loading step 502, where a continuous feed dye sublimation apparatus may receive a continuous (or substantially continuous) feed of printed sheet and a substrate. The printed sheet may include an image formed by one or more sublimation dyes. The image may be infused into the substrate after the completion of the sublimation cycle. A worker may manually feed the continuous feed into the dye sublimation apparatus, or the dye sublimation apparatus may be directly coupled to an extrusion machine that produces the substrate.

At a pre-heating step 504, a front zone of conveyor belts of the continuous feed dye sublimation apparatus may pre-heat the printed sheet and the substrate. The front zone may include a heater or a plurality of heating elements that may cause a relatively low amount of heat to radiate on the printed sheet and the substrate to warm the combination but not begin the sublimation of the dye itself. A processor may control the front zone heater to cause the heater until reaching a requisite temperature.

At a heating step 506, a middle or end zone of conveyor belts of the continuous feed dye sublimation apparatus may heat the printed sheet and the substrate such that the one or more dyes forming the image on the printed sheet sublimate and travel into the substrate in a gaseous state. The sublimated dyes deposit into the substrate as solid thereby infusing the image into the substrate. A processor may control a heater or a plurality of heating elements in the middle zone such that the middle zone maintains a requisite temperature for infusing the image through dye sublimation.

At an unloading step 508, the printed sheet and substrate, which has received the sublimated dyes, are output from the continuous feed dye sublimation apparatus and can be removed by a worker or fed into another machine (e.g., a cutting machine). When a sublimation bed arrives back at the output of the continuous feed dye sublimation apparatus, the printed sheet and substrate may have undergone the steps of the dye sublimation cycle and are ready to be removed. The worker may unload the arriving printed sheet and substrate or feed the substrate into another machine for cutting and trimming.

The foregoing method descriptions and the process flow diagrams are provided merely as illustrative examples and are not intended to require or imply that the steps of the various embodiments must be performed in the order presented. The steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations can be performed in parallel or concurrently. In addition, the order of the operations may be re-arranged. A process may correspond to a method, a function, a procedure, a subroutine, a subprogram, and the like. When a process corresponds to a function, the process termination may correspond to a return of the function to a calling function or a main function.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of this disclosure or the claims.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module, which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the embodiments described herein and variations thereof. Various modifications to these embodiments will be readily apparent to those skilled in the art, and the generic principles defined herein may be applied to other embodiments without departing from the spirit or scope of the subject matter disclosed herein. Thus, the present disclosure is not intended to be limited to the embodiments shown herein but is to be accorded the widest scope consistent with the following claims and the principles and novel features disclosed herein.

While various aspects and embodiments have been disclosed, other aspects and embodiments are contemplated. The various aspects and embodiments disclosed are for purposes of illustration and are not intended to be limiting, with the true scope and spirit being indicated by the following claims.

What is claimed is:

1. A continuous feed dye sublimation machine for infusing an image from a printed sheet to a substrate, the dye sublimation machine comprising:
one or more conveyor belts, the one or more conveyor belts structured to receive the printed sheet and the substrate and apply pressure to the printed sheet and the substrate; and
a plurality of heating elements, the plurality of heating elements contained within the one or more conveyor belts and structured to heat the printed sheet to sublimate one or more dyes forming the image, such that the one or more dyes travel to the substrate in a gaseous state and deposit into the substrate in a solid state thereby infusing the image into the substrate,
wherein at least one of the printed sheet or the substrate are received in a substantially continuous feed.

2. The dye sublimation machine of claim 1, wherein the dye sublimation machine is directly coupled to an extrusion machine that produces the substrate.

3. The dye sublimation machine of claim 2, wherein the one or more conveyor belts are structured to receive the substrate directly from an extrusion machine.

4. The dye sublimation machine of claim 1, further comprising a processor configured to individually control each of the plurality of heater elements.

5. The dye sublimation machine of claim 4, wherein the processor maintains a substantially constant temperature across the one or more conveyor belts.

6. The dye sublimation machine of claim 4, wherein the processor maintains a temperature gradient across the one or more conveyor belts, the temperature gradient increasing in the direction of movement of the printed sheet and the substrate.

7. The dye sublimation machine of claim 4, wherein the processor maintains a pre-heating temperature for a first subset of the plurality of heater elements and a dye sublimation temperature for a second subset of the plurality of heater elements.

8. The dye sublimation machine of claim 1, further comprising a processor configured to individually control a rotation of the one or more conveyor belts to control a speed at which the printed sheet and substrate move.

9. The dye sublimation machine of claim 1, further comprising one or more unheated conveyor belts structured to receive the printed sheet and substrate prior to the one or more conveyor belts.

10. The dye sublimation machine of claim 1, wherein the plurality of heating elements comprises a first heating element at a pre-heating temperature and a second heating element at a dye sublimation temperature.

11. The dye sublimation machine of claim 1, wherein the substrate is less than 0.028 inches thick.

12. A dye sublimation method for infusing an image formed by one or more dyes on a printed sheet to a substrate, the method comprising:
receiving a continuous feed of a printed sheet and a continuous feed of a substrate;
pre-heating, via a first heating element, the printed sheet and the substrate to a first temperature below a dye sublimation temperature;
heating, via a second heating element, the printed sheet and the substrate to at or above a dye sublimation temperature to sublimate one or more dyes forming the image, such that the one or more dyes travel to the substrate in a gaseous state and deposit into the substrate in a solid state thereby infusing the image into the substrate.

13. The dye sublimation method of claim 12, wherein the first heating element is at least partially included within a first conveyor belt and the second heating element is at least partially included within a second conveyor belt.

14. The dye sublimation method of claim 12, further comprising receiving the continuous feed of the substrate directly from an extraction machine that produces the substrate.

15. The dye sublimation method of claim 12, further comprising receiving, via one or more conveyor belts, the continuous feed of the printed sheet and the continuous feed of the substrate, the one or more conveyor belts structured to receive the printed sheet and the substrate and apply pressure to the printed sheet and substrate.

16. The dye sublimation method of claim 15, wherein the first heating element is included in a front zone of the one or more conveyor belts, and wherein the second heating element is included within at least one of a middle or end zone of the one or more conveyor belts.

17. The dye sublimation method of claim 12, wherein the first heating element comprises a plurality of individually controllable heating elements.

18. The dye sublimation method of claim 12, further comprising controlling, via a controller, a speed at which the continuous feed of the printed sheet and the continuous feed of the substrate are received.

19. The dye sublimation method of claim 12, further comprising providing the substrate infused with the image directly to a cutting machine.

20. A continuous feed dye sublimation machine for infusing an image from a printed sheet to a substrate, the dye sublimation machine comprising:
a plurality of conveyor belts, the plurality of conveyor belts structured to receive the printed sheet and the substrate and apply pressure to the printed sheet and the substrate; and
a plurality of heating elements, wherein at least one of the plurality of heating elements is contained within each of the plurality of conveyor belts, the plurality of heating elements structured to heat the printed sheet and substrate via the plurality of conveyor belts,
wherein at least one of the plurality of conveyor belts includes a first heating element of the plurality of heating elements structured to heat the printed sheet and substrate to a first temperature below a dye sublimation temperature,
wherein at least one of the plurality of conveyor belts includes a second heating element of the plurality of heating elements structured to heat the printed sheet and substrate to sublimate one or more dyes forming the image, such that the one or more dyes travel to the substrate in a gaseous state and deposit into the substrate in a solid state thereby infusing the image into the substrate, and
wherein at least one of the printed sheet or the substrate are received in a substantially continuous feed.
